(19) United States
(12) Patent Application Publication
(10) Pub. No.: US 2023/0140190 A1
(43) Pub. Date: May 4, 2023

(54) BUFFERING SERVICES FOR SUPPLIERS

(71) Applicant: Onriva LLC, Foster City, CA (US)

(72) Inventors: Vajid H. Jafri, Redwood Shores, CA (US); Hassan J. Abbas, Brisbane, CA (US); Michael Joseph d’Almada-Remedios, Discovery Bay, CA (US)

(21) Appl. No.: 17/517,405

(22) Filed: Nov. 2, 2021

(51) Int. Cl. G06Q 20/40; G06Q 20/38

(52) U.S. Cl. CPC G06Q 20/4016; G06Q 20/4014; G06Q 20/405; G06Q 20/3821

(57) ABSTRACT

Methods for reducing fraudulent activities associated with credit card and debit card usage can include a better authentication process, such as getting to know the customers, thus can detect the fraudulent activities when the credit payments do not fit the usage patterns of the customers. The method can include replacing a payment from a customer to a supplier with a different payment from a platform to the supplier.

### BACKGROUND

Services through the Internet are constantly increasing. The Internet enables one to purchase services and products using on-line services. Payments for on-lines services are typically through credit cards and debit cards. Originally, a customer would present a credit card to a merchant, and the merchant simply accepts the credit card payment.

Then fraud became widespread. As the use of credit cards on the Internet increases, so too does the increase of credit card fraud, e.g., misused by a malevolent eavesdropper or untrustworthy payee.

To prevent fraud and other financial losses, credit card companies impose spending limits and issuing printed lists of lost/stolen cards, but the process is proved ineffective in preventing fraud. As an added measure, the merchants are required to contact a transaction authorization center to get pre-approval for transactions.

To improve the authorization process, such as to create additional barriers for fraudsters, additional security measures, such as magnetic stripes or embedded chips, were added to the credit cards. These additional barriers can allow near real-time control of fraudulent card usage. But detecting and reacting appropriately to fraud remained a problem.

FIGS. 1A-1B illustrate prior art payment scheme according to some embodiments. A customer 110 can contact a supplier 120, for example, to inquire about a product of service offered by the supplier. The contact can be performed through the Internet. After deciding on a product or service, the customer can send a payment, such as a credit card payment 140, to the supplier. The supplier then sends the credit card information to a credit card processing service, for example, to get approval for the credit card payment.

The supplier is partially responsible for the credit card payment, e.g., when the transaction is a fraudulent transaction, the supplier incurs a loss associated with the fraudulent credit card.

Therefore, a need exists for an improved system to reduce credit card losses for the suppliers.

### SUMMARY

In some embodiments, the present invention discloses methods and systems for reducing fraudulent activities associated with credit card and debit card usage. The methods can potentially reduce payment card fraud, for example, through a better authentication process, such as getting to know the customers, thus can detect the fraudulent activities when the credit payments do not fit the usage patterns of the customers. For example, the systems can maintain a database for storing customer information related to the customer habits in credit purchases, with the database used for verifying the authenticity of the credit charges incurred by the customers. The database can be periodically updated, for example, with credit information from credit agencies, such as credit report or score from the credit bureau, and with credit information of the customers collected and processed by the system, including address, password, date-of-birth or other password-verifying information. Further, the credit information can be processed by a machine learning algorithm, such as an artificial intelligence, to identify spending patterns of the customers, which can help in identifying fraudulent activities, e.g., activities not fitted in the customer spending habit.

In some embodiments, the present invention discloses a method, and a platform to perform the method, for forming a buffering service between customers and suppliers. The buffering service can be configured to replace a payment from a customer to a supplier with a different payment.

In some embodiments, the present invention discloses a method for a buffering service between customers and suppliers. The method can include receiving a payment from a customer. The customer payment can be payment for a service or product offered by a supplier and purchased by the customer.

The method can further include assessing a characteristic of the customer payment using a database. The characteristic can include an identity characteristic, such as the identity of the owner of the credit card, for example, to prevent the credit payment from a stolen credit card.

The method can further include issuing a different payment to the supplier for the service or product. The payment, such as a credit card payment, can be made from the buffering service to the supplier. Thus, the payment can be secured.

In some embodiments, the present invention discloses a service platform that can aggregates and intelligently orchestrates several payment platforms to enable and optimize global and local payment types and terms for consumers, while shielding suppliers from the diverse operational complexities of accepting and managing risk, fraud and chargebacks through those many payment methods.

This enables consumers to buy products however they want, and provides suppliers a quick and easy way to maximize their sales while simplifying their payment related operational complexity, cost and fraud losses.

### BRIEF DESCRIPTION OF THE DRAWINGS

FIG. 1 illustrates a prior art payment scheme according to some embodiments.

FIGS. 2A-2B illustrate a database for storing customer information according to some embodiments.

FIG. 3 illustrates a platform for maintaining a customer credit database according to some embodiments.

FIGS. 4A-4D illustrate flow charts for forming a customer credit database according to some embodiments.

FIGS. 5A-5B illustrate flow charts for updating a customer credit database according to some embodiments.

FIGS. 6A-6B illustrate configurations of a buffering service according to some embodiments.

FIGS. 7A-7D illustrate flow charts for forming a buffering service according to some embodiments.

FIG. 8 illustrates a flow chart for performing a buffering service according to some embodiments.

FIGS. 9A-9B illustrate schematics of processing a payment from a customer according to some embodiments.

FIGS. 10A-10B illustrate flow charts for processing a payment from a customer according to some embodiments.

FIGS. 11A-11B illustrate schematics for processing a payment to a supplier according to some embodiments.

FIGS. 12A-12B illustrate flow charts for processing a payment to a supplier according to some embodiments.

FIGS. 13A-13B illustrate schematics for payment configurations to a supplier according to some embodiments.

FIGS. 14A-14C illustrate flow charts for payment configurations to a supplier according to some embodiments.

FIG. 15 illustrates a schematic for a buffering configuration according to some embodiments.

FIGS. 16A-16C illustrate flow charts for shielding configurations to a supplier according to some embodiments.

FIG. 17 illustrates a schematic of a buffering service platform according to some embodiments.

FIG. 18 illustrates a flow chart for forming a buffering service platform according to some embodiments.

FIG. 19 illustrates a flow chart for forming a travel reservation platform according to some embodiments.

FIGS. 20A-20D illustrate operation schematics for a buffering service platform according to some embodiments.

FIG. 21 illustrates a flow chart for operating a buffering service platform according to some embodiments.

FIG. 22 illustrates a flow chart for operating a travel reservation platform according to some embodiments.

FIGS. 23A-23B illustrate computing environments according to some embodiments.

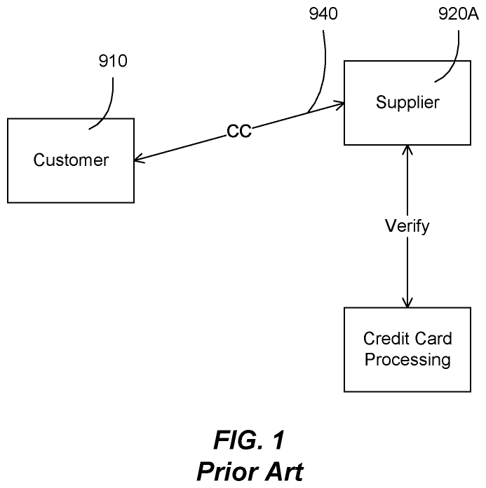

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In some embodiments, the present invention discloses methods and systems for reducing fraudulent activities associated with credit card and debit card usage, such as for authentication and verification of credit card payments via telecommunications and for detecting credit card fraud attempts from credit purchases. The methods can potentially reduce payment card fraud, such as through automated payment card fraud detection. For example, the methods can provide better authentication when a customer performs credit payments to a supplier.

In some embodiments, the methods can include getting to know the customers, thus can detect the fraudulent activities when the credit payments do not fit the usage patterns of the customers. For example, the systems can maintain a database for storing customer information related to the customer habits in credit purchases, with the database used for verifying the authenticity of the credit charges incurred by the customers. The database can be periodically updated, for example, with credit information from credit agencies, such as credit report or score from the credit bureau, and with credit information of the customers collected and processed by the system, including address, password, date-of-birth or other password-verifying information. Further, the credit information can be processed by a machine learning algorithm, such as an artificial intelligence, to identify spending patterns of the customers, which can help in identifying fraudulent activities, e.g., activities not fitted in the customer spending habit.

In some embodiments, the present fraud detection method can verify that the customer providing a credit payment is the actual owner of the credit card. A credit card can have embedded elements that can uniquely identify the account cardholder. For example, a credit card number can have a system number, a bank or product number, a user account number, and a check digit. The credit card number is typically sixteen digits. The first six digits are the bin number of the credit card, and represent the card network, the bank and the product for this bank. The last digit is reserved for the checksum of the previous digits of the credit card number. The credit card can also include an expiration date, and the cardholder's name or business.

To reduce fraud, several security features have been added to payment cards. For example, a pin code is primarily used for debit card-present transactions, and is remembered by the cardholder. Another feature is a Card Verification Value (CVV), Card Verification Code (CVC), or a second CVC (CVV2) on the credit card.

A major type of transactions is “Card-Present”, in which the credit card is presented for the transactions, such as for point-of-sale (POS) or Automatic Teller Machines (ATM). Card-Present transactions involve magnetic card or embedded chip readers, and can make use of the full digits of the credit card number, together with the 4-digit expiration date.

For e-commerce, more and more transactions are becoming “Card-Not-Present”, in which the credit card is not presented for the transactions, such as for Internet and on-line transactions. Generally, Card-Not-Present transactions require the user to enter the credit card number, the expiration data, and sometimes the CVC/CVV2 number.

Card-Not-Present transactions are likely to be subject fraud. To limit these fraudulent activities, various fraud detection and prevention methods have been developed, such as the use of Virtual Account numbers, authentication of cardholders separate from transaction, and use of hardware token to authenticate the user.

For example, a Virtual Account Number, which is a substitute single-use credit card number, can allow customers to shop online without having to transmit their actual card details over the Internet. A limitation with using Virtual Account Numbers is to get new number for each transaction. Another authentication process is a direct request from the bank to the customer to verify the transaction. This request will let the bank knows that the right person is making the purchase.

For example, a potential fraudulent activity is the occurrence of transactions which occur concurrently or which are placed from different geographic regions within a sufficiently short time interval.

Another potential fraudulent activity detection can include comparing the identification of the customer telecommunication, such as the country, the IP address or the computer identification with a predetermined list of suspected fraud users.

Another potential fraudulent activity detection can include a list of locations and date when the fraudulent activities occur, for example, by having sufficient data to determine when, e.g., by the transaction date, and where, e.g., by the merchant ID.

In some embodiments, the present fraud detection can include additional security authentications will need additional forms of identification, in addition to their credit or debit card details. The additional identification can include customer's knowledge, such as password, PIN number, secret questions, or a numerical sequence; customer possession, such as mobile phone, wearable devices, token, or smartcard; or customer inherent feature, such as fingerprint, voice recognition, iris recognition, or facial features.

In some embodiments, the additional security authentications can include Two Factor Authentication, such as One Time Passwords and biometric authentication. The biometric method, such as using fingerprints or facial recognition, can greatly reduce the amount of fraud while not presenting additional inconvenience for the customers.

The additional security authentications can include using a larger number of data to be verified in the credit card transactions. For example, the data can be obtained from the bank. The data can be supplied by the customers, such as the email address or billing address. The data can come from the customer's device and browser data.

In some embodiments, the credit transaction can be authenticated through a risk-based authentication, which is the process of determining the risk attached to a particular transaction. And then based on the risk level, additional authentication steps should be required from the customers. The risk-based elements can include the value of the transaction, a new or existing customer, a transactional history, a behavioral history, and the device information of the customer.

For example, if a new card is used with no transactional history, the risk can be high, and additional authentication steps will be required. If there is a purchase history but the transaction is performed on a new device, additional authentication steps can be needed since there is an unknown variable. In contrast, if the card is already in the system with the customer using the card to make payments, the risk can be low. The system can authenticate the credit transaction without the need for additional authentication steps.

In general, the additional security authentications can be applied to the customers until the credit card issuing banks have sufficient data and confidence to for the risk-assessment of the credit card transactions.

In some embodiments, the present invention discloses a machine learning process, such as using an artificial intelligence (AI) algorithm, to assist in processing the incoming data to be stored in the database. The machine learning process can also be configured to process data from the database for the authentication and verification of the credit payments of the customers. For example, the database can store information and activities from the customer. The AI algorithm can assemble patterns of spending of the customers, and can assist in detecting potential deviation from the spending patterns, which can serve as indications of fraud.

AI algorithm can quickly complete the fraud detection analysis to obtain and detect complex pattern deviations, much faster and complete than human fraud analysts. The AI algorithm can perform the time-consuming and routine tasks, with the human fraud analysts focusing on critical cases.

AI algorithm can be programmed to detect anomaly behaviors of the customers, for example, by comparing the current credit payments of the customers with the customer profiles or patterns, such as processing all the customer data collected by the database with AI pattern recognition algorithms and machine learning. The customer patterns can include average and standard deviation values, including moving averages.

For example, an anomaly event is an event that rarely happens. When the AI anomaly detection identifies that the current credit payment does not generally occur for the customer, e.g., the credit payment is outside of the normal purchase behavior of the customer, the system can determine that the credit risk can be high, and thus can require additional authentication steps.

The customer profiles used in AI anomaly detection can include historical usage patterns of customer credit cards and other predictive triggers. A potential fraud is suggested for any indication of a deviation in the historical usage patterns. For example, if a customer incurs a large oversea purchase after a long period of local credit purchases, it can indicate a potential fraudulent transaction. Additional security measures to determine the customer identity can be required. Other anomaly activities can include a quick series of electronic equipment purchases after normally using the credit card for small everyday purchases, such as gas and groceries.

Other anomaly activities can include deviations from communication behavior, such as communication duration (the average length in time of a communication), communication velocity (the number of communication in a specified time period), and communication thresholds (the highest number of communication in a specified time period).

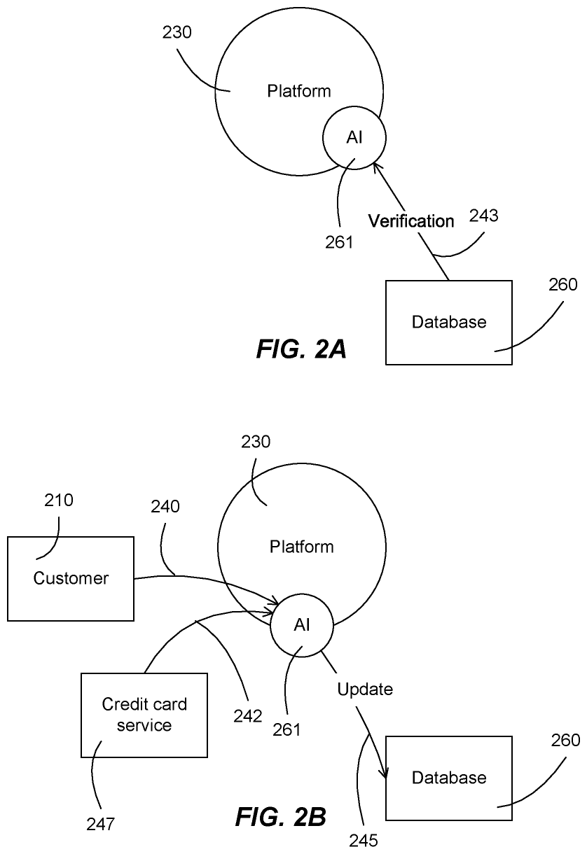

FIGS. 2A-2B illustrate a database for storing customer information according to some embodiments. In FIG. 2A, a system, such as a platform 230, can have an AI module 261, e.g., a program having a machine learning or AI algorithm, for processing data from a database 260. In operation, after the platform receives a credit payment from a customer, AI processed data 243 from the database can be used to verify the authentication of the credit purchase, such as to the identity of the customer.

In FIG. 2B, the platform 230 can receive 242 data from credit agencies 247, such as from a credit report agency, from data in the public domain, or from a banking institution, for information regarding the customers, such as credit history and other personal information. The data can be directly stored in the database 260, or can be processed by the AI module 261, such as for pattern analysis, before storing or updating 245 the raw data and the processed data in the database 260. The processed data can speed up the credit authentication process, e.g., allowing the customer usage patterns to be determined before an analysis of a new credit payment.

The platform 230 can also receive 240 data from the customers 210, such as from customer profiles supplied by the customers, or from data inferred from the customer location (through IP address, for example) and from customer equipment (through the equipment ID of the customer computer or cell phone). The data can be directly stored in the database 260, or can be processed by the AI module 261 before being stored in the database 260.

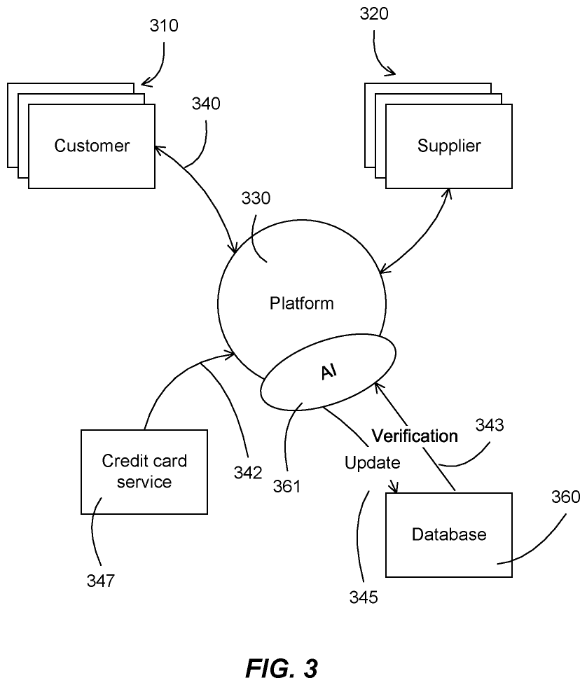

FIG. 3 illustrates a platform for maintaining a customer credit database according to some embodiments. A platform 330 can be configured to provide products and services from one or more suppliers 320 to customers 310. For example, the platform can have access to the inventories of the suppliers, such as a list of products and services with their description. Upon receiving an inquiry from a customer, the platform can search the inventories and then display the search results for the customer. The customer can select one or more products or services, and can proceed for payment, such as by a credit card. The platform can process the credit payment, using a database 360, e.g., using data from the database to verify 343 the authentication of the credit purchase, such as to the identity of the customer, or the credit limit imposed by the credit card issuer.

In some embodiments, the platform 330 can have an AI module 361, which can be equipped with AI or machine learning, to assist in the analysis of the credit purchase. Data in the database can be added 345 from credit agencies 347, such as from credit card services. Data in the database can be added 340 from the customers 310, such as from customer profiles supplied by the customers, or from data inferred from the customer communication with the platform such as the customer location and communication equipment. The usage of a database together with AI or machine learning can allow an improvement in fraud detection.

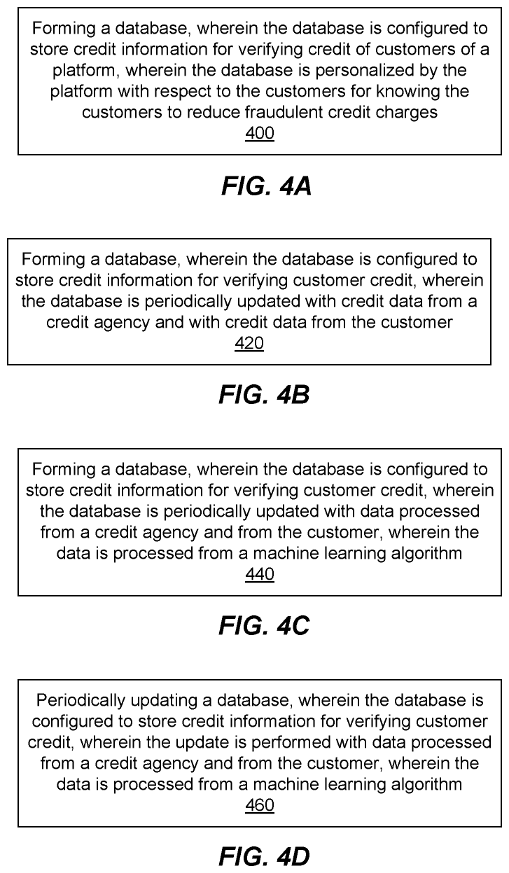

FIGS. 4A-4D illustrate flow charts for forming a customer credit database according to some embodiments. In FIG. 4A, operation 400 forms a database, with the database configured to store credit information for verifying credit of customers of a platform. Data in the database can be personalized by the platform with respect to the customers for knowing the customers to reduce fraudulent credit charges.

In FIG. 4B, operation 420 forms a database, with the database configured to store credit information for verifying customer credit. Data in the database can be periodically updated with credit data from a credit agency and with credit data from the customer.

In FIG. 4C, operation 440 forms a database, with the database configured to store credit information for verifying customer credit. Data in the database can be periodically updated with data processed from a credit agency and from the customer, with the processed data generated by a machine learning or AI algorithm.

In FIG. 4D, operation 460 periodically updates a database, with the database configured to store credit information for verifying customer credit. The database update is performed with data processed from a credit agency and from the customer, with the processed data generated by a machine learning or AI algorithm.

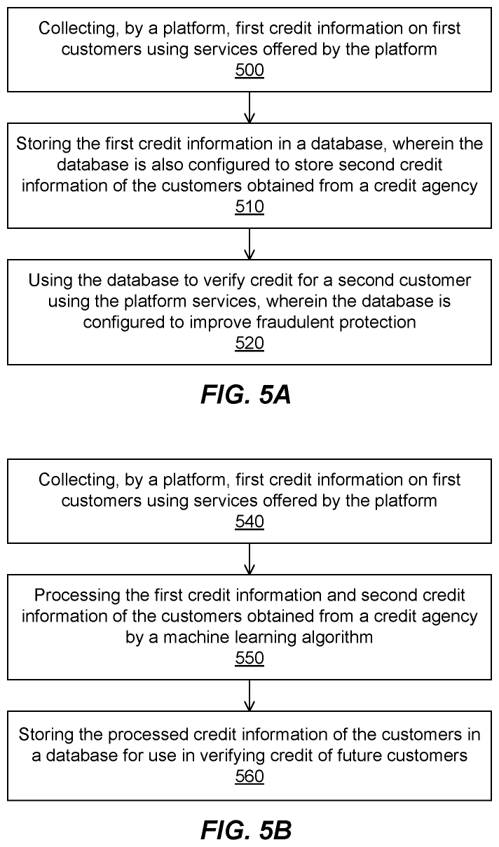

FIGS. 5A-5B illustrate flow charts for updating a customer credit database according to some embodiments. In FIG. 5A, operation 500 collects, by a platform, first credit information on first customers using services offered by the platform. Operation 510 stores the first credit information in a database, wherein the database is also configured to store second credit information of the customers obtained from a credit agency. Operation 520 uses the database to verify credit for a second customer using the platform services, wherein the database is configured to improve fraudulent protection.

In FIG. 5B, operation 540 collects, by a platform, first credit information on first customers using services offered by the platform. Operation 550 processes the first credit information and second credit information of the customers obtained from a credit agency by a machine learning algorithm. Operation 560 stores the processed credit information of the customers in a database for use in verifying credit of future customers.

In some embodiments, the present invention discloses a method, and a platform to perform the method, for forming a buffering service between customers and suppliers. The buffering service can shield the suppliers from fraudulent charges, for example, from determining if a payment from the customers is legitimate or to handle any post sale transactions and disputes. The buffering service can be configured to shield the supplier from financial risks relating to the customer, e.g., from the customer payment. The buffering service can also function as a one-stop shop for the customers, e.g., the customers can discuss post sale transactions with the buffering service, instead of dealing with multiple suppliers with different procedures and paperwork.

In some embodiments, the buffering service can be configured to replace a payment from a customer to a supplier with a different payment. For example, the customer payment can be a credit payment from the customer, sending to the buffering service to pay for a product or service from the supplier. The customer payment can be a high risk payment, such as due to a fraudulent transaction, e.g., from a customer with bad credit, or from an unauthorized person performing the credit payment. The payment from the buffering service can be a secured payment, based on the reputation of the buffering service, especially for suppliers having prior engagements with the buffering service. By accepting payments from the customers, the buffering service is in a position to accept the financial risks, for example, due to fraudulent payments, and to shift the financial risks from the suppliers to the buffering service. The buffering service is thus configured to handle customer problems related to fraudulent payments, and can also represent the suppliers to discuss problems with the customers.

In some embodiments, the buffering service can be run on a platform, such as on a server communicating with customers and suppliers through a network, such as the Internet. The platform can be configured to provide products and services from multiple suppliers to customers looking for products or services through the platform. For example, the platform can have access to the inventories of the suppliers, including products and services offered by the suppliers together with their description and other information such as product reviews or rating.

In operation, a customer can send an inquiry to the platform, indicating the items the customer would like to see. The platform can search the inventories from the suppliers and then display the search results to the customer. The customer can select one or more products or services, and can proceed for payment, such as by sending a credit card, a debit card, or other types of payment to the platform. The platform can process the payment, such as checking for fraudulent activities, and then proceed to send a different payment to the supplier.

In some embodiments, the present invention discloses a method for a buffering service between customers and suppliers. The method can include receiving a payment from a customer. The payment can be a credit card payment, a debit card payment, a cash payment, a wire transfer payment, a bank transfer payment, a check payment, a cashier check payment, or a payment through a payment agency such as Paypal. The customer payment can be payment for a service or product offered by a supplier and purchased by the customer.

In some embodiments, the customer payment is an on-line payment, e.g., without the presence of the customer or the means of payment, such as the credit card or the debit card. Thus, the customer payment is subjected to a fraudulent risk, for example, due to a stolen credit card, a customer having bad credit or exceeding the credit limit of the credit card.

The method can further include assessing a characteristic of the customer payment using a database. The characteristics can include a financial characteristic, such as a risk rate, a credit score, a trustworthiness of the payment. The financial characteristic can include an interest rate of the credit card, or an interchange fee imposed on the credit transactions by the bank issuing the credit card. The characteristic can include an identity characteristic, such as the identity of the owner of the credit card, for example, to prevent the credit payment from a stolen credit card.

In some embodiments, the buffering service can include an AI-processed database for a better authentication and verification of the credit payment, thus can significantly reduce the fraudulent risk for the buffering service. Thus, the database can be configured to provide an estimate of the characteristic, e.g., an assessment of the fraudulent risk associated with the credit card payment. Further, the database is configured to be periodically updated to provide a better estimate of the characteristic of the credit card transaction.

In some embodiments, the buffering service can have an AI module, which can be equipped with AI or machine learning, to assist in the analysis of the credit purchase. Data in the database can be added from credit agencies, such as from credit card services. Data in the database can be added from the customers, such as from customer profiles supplied by the customers, or from data inferred from the customer communication with the platform such as the customer location and communication equipment. The usage of a database together with AI or machine learning can allow an improvement in fraud detection.

The method can further include issuing a different payment to the supplier for the service or product. The payment, such as a credit card payment, can be made from the buffering service to the supplier. Thus, the payment can be secured, at least in the buffering service point of view. For suppliers having prior engagements with the buffering service, the payment is also secured, since it comes from a trusted service, e.g., a service that the suppliers are comfortable with listing their products for sale.

In some embodiments, the payment from the buffering service to the platform is a credit card payment, such as a payment from a one-time-use credit card. For example, the buffering service can have an agreement or a contract with a credit issuing institution, such as a bank, to issue multiple one-time-use credit cards. The one-time-use credit card is a credit card configured to be used only one time, such as a virtual credit card or a temporary credit card.

A virtual credit card is a randomly generated 16-digit number associated with an actual credit card account. The virtual credit card can be issued by the issuing bank of the credit card account, for example, to protect against fraud for shopping without presenting the physical credit card. The virtual credit card sometimes can be called a temporary card number or a pseudo card number. The virtual credit card can have a credit or debit card number, which can be used for secured online purchases. The virtual card can have a maximum charge limit to prevent overcharged. The virtual card can be locked to a specific supplier to prevent the card from being used elsewhere.

In some embodiments, the one-time-use credit card can be linked to a credit card of the buffering service. However, the one-time-use credit does not have to be linked to a credit card. For example, the one-time-use credit card can be issued by the bank based on an agreement with the buffering service, and can be secured by the credit or collateral from the buffering service.

In some embodiments, the one-time-use credit card carries the name of the customer. The customer name on the credit card can let the supplier know that the credit card payment is from the customer. Additionally, the one-time-use credit card carrying the customer name can shield the buffering service from the obvious payment trail, e.g., from the supplier point of view, the payment is made by the customer, and not a different payment from the buffering service.

The one-time-use credit card can also be selected to be a similar credit card type as the credit card used by the customer to pay for the product or service. For example, if the customer uses a Visa card to pay, the one-time-use credit card can also be a Visa card. The one-time-use credit card can be selected to have a few of the credit card numbers to be similar to the credit card used by the customer.

In some embodiments, the present specification relates to credit card payments, e.g., payments by a credit card or by a debit card. A credit or debit card can have a cardholder, e.g., the owner of the credit or debit card, such as a person or a corporation. The name of the cardholder can be present on the credit or debit card. The cardholder can open an account with bank issuing the credit or debit card, and can obtain a credit or debit card from the issuing bank. The cardholder can use the account to pay for goods or services using the credit or debit card, to a supplier or a merchant.

The supplier or the merchant is a company offering products or services, and can accept card payments in exchange for the goods or services. The merchant can establish a merchant account with a merchant bank, which can allow the merchant to accept deposits from credit and debit card payments.

When the customer pays the merchant with a credit or debit card, the payment can go through a payment processor, which is a company that processes credit and debit card transactions. The payment processors connect the merchant, the merchant bank, the customer, and the customer issuing card bank to perform the credit or debit card payments.

The issuing banks can issue credit and debit cards to cardholders through the card associations, which include Visa, MasterCard, Discover and American Express. The card associations set interchange rates and serve to settle disputes between the issuing banks and the merchant banks.

In operation, the customer first provides a payment through his credit or debit card to a merchant to pay for the products or services. The merchant then sends a request for payment authorization to a payment processor. The payment processor submits transactions to the appropriate card association, and eventually reaching the issuing bank. The issuing bank approves or declines the transaction. The issuing bank then sends the approval or denial decision back to the card association, merchant bank and to the merchant.

After a certain period of time, such as at the end of a business day, the merchant send the authorized transactions, e.g., credit or debit card payment receiving the approval decision from the issuing bank, to the payment processor. The payment processor then sends details of the transactions to the card associations, which then communicates with the issuing bank. The issuing bank charges the account of the cardholder for the amount of the transactions, and then transfers appropriate transaction payments to the merchant bank, minus interchange fees, which are transaction fees that the merchant bank account must pay to the card issuing bank to cover handling costs, fraud, bad debt costs and the risk involved in approving the payment. Upon receiving the payments, the merchant bank deposits the payments into the merchant account.

In some embodiments, the method can control or limit the risk of non-payment to the supplier by the buffering service accepting the risk and by the buffering service sending secured payments to the supplier. The method can protected the suppliers from fraudulent chargebacks by the buffering service accepting the credit or debit payments. The method can also protected the buffering service from fraudulent chargebacks by an AI authentication process through an AI module with a large and constantly updated database.

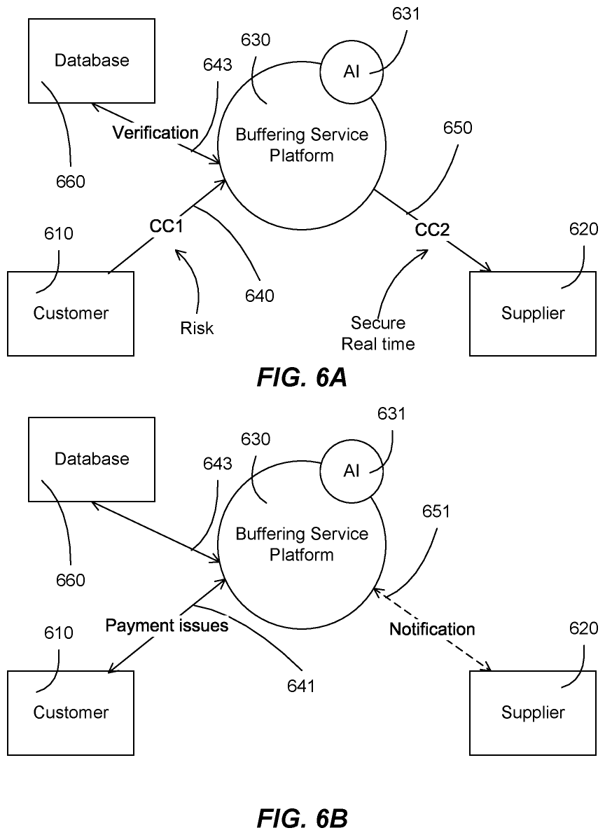

FIGS. 6A-6B illustrate configurations of a buffering service according to some embodiments. The buffering service can be configured to receive payments from customers, and then send another payment to suppliers. The buffering service can include a constantly update database to know customer credit information, agreements with banks to generate credit or debit used for payment. The buffering service can function as a one stop shop for customer in dealing with multiple suppliers, and can handle all post sale transactions for the suppliers.

In FIG. 6A, a buffering service platform 630 can be configured to provide products and services from one or more suppliers 620 to customers 610. For example, upon receiving an inquiry from a customer, the platform can search inventories of the suppliers and then display the search results for the customer. The customer can select one or more products or services, and can proceed 640 for payment, such as by a credit card CC1. The platform can process the credit payment, using a database 660, e.g., using data from the database to verify 643 the authentication of the credit purchase, such as to the identity of the customer, or the credit limit imposed by the credit card issuer. In some embodiments, the platform 630 can have an AI module 661, which can be equipped with AI or machine learning, to assist in the analysis of the credit purchase.

The platform then can send 650 another different payment CC2 to the supplier. The payment from the platform can be more secured than the payment from the customer, since the platform is known to the supplier, for example, through an agreement to display products or services on the platform.

In FIG. 6B, the platform can be configured to handle all post sale transactions from the customer. The customer can communicate 641 with the platform regarding issues related to the payment from the customer, such as a fraudulent transaction from a stolen credit card. The platform can settle the fraud charges with the customer, without involving the supplier. For issues related to the products or services obtained by the customer, such as a broken product or a poor-performance service, the platform can function as an intermediate or an arbiter between the customer and the supplier. For example, the platform can discuss 641 the issues with the customer, and also discuss 651 the issues with the supplier using the argument with the customer. Thus, the customer and the supplier can be seen as dealing only with the platform.

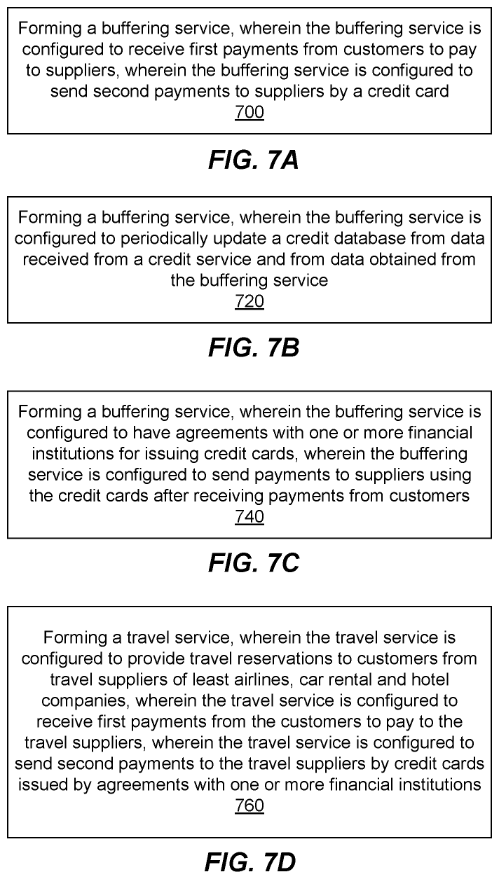

FIGS. 7A-7D illustrate flow charts for forming a buffering service according to some embodiments. In FIG. 7A, operation 700 forms a buffering service. The buffering service is configured to receive first payments from customers to pay to suppliers. The buffering service is configured to send second payments to suppliers by a credit card.

In FIG. 7B, operation 720 forms a buffering service, with the buffering service configured to periodically update a credit database from data received from a credit service and from data obtained from the buffering service.

In FIG. 7C, operation 740 forms a buffering service. The buffering service is configured to have agreements with one or more financial institutions for issuing credit cards. The buffering service is configured to send payments to suppliers using the credit cards after receiving payments from customers.

In FIG. 7D, operation 760 forms a travel service. The travel service is configured to provide travel reservations to customers from travel suppliers of least airlines, car rental and hotel companies. The travel service is configured to receive first payments from the customers to pay to the travel suppliers. The travel service is configured to send second payments to the travel suppliers by credit cards issued by agreements with one or more financial institutions.

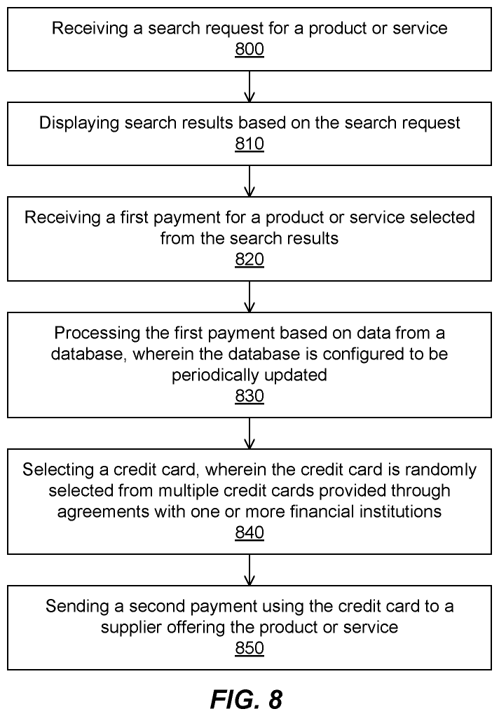

FIG. 8 illustrates a flow chart for performing a buffering service according to some embodiments. Operation 800 receives a search request for a product or service. Operation 810 displays search results based on the search request. Operation 820 receives a first payment for a product or service selected from the search results. Operation 830 processes the first payment based on data from a database, wherein the database is configured to be periodically updated. Operation 840 selects a credit card, wherein the credit card is randomly selected from multiple credit cards provided through agreements with one or more financial institutions. Operation 850 sends a second payment using the credit card to a supplier offering the product or service.

In some embodiments, the buffering service can be configured to process and receive a payment from a customer. By providing an AI processed database, the buffering service can perform prescreen on the identity of the customer, such as through additional security verification. The prescreening process can eliminate or significantly reduce the risk of fraudulent payment transactions.

For example, the customer verification can first include verifying a location of the customer together with a verification of the equipment that the customer uses to perform the payment. The customer verification can include an anomaly detection, performed by an AI module based on the AI processed database, to see if the current payment behavior fits into the customer payment patterns or if the current payment behavior provides an indication of a deviation from the customer payment patterns. The additional security verification can continue until the AI module is satisfied that the fraudulent risk is low, e.g., there is a very high chance that the customer is indeed the owner of the credit card presented for payment.

In addition, the buffering service can further reduce the fraudulent transactions for the suppliers by accepting the fraudulent risk through accepting the payments from the customers, and then issue other payments to the suppliers, using the buffering service credit.

In some embodiments, the buffering service can include a database for processing payments from customers. The database can be updated using a machine learning methodology or AI. The database can be used to process the credit payments from the customers, such as to verify that the customer is the owner of the credit card used in the payment. The database can be used to verify financial information related to the customer and to the credit card used by the customer, such as to determine an interchange fee for the credit card used by the customers.

In some embodiments, some financial aspects of the customer credit can be verified by a credit check, for example, the credit limits of the credit card or the credit worthiness of the customer.

In some embodiments, an AI algorithm can be used for processing the data from the database, for example, to generate spending patterns of the customer. The AI module can also be used to calculate a probability that the current payment is within or outside the normal ranges of the customer spending habit or patterns.

The database can be constantly updated, for example, to include up-to-date data by adding new data. The database can periodically or constantly update with data from credit agencies, from the customers, and from public or private institutions. For example, the interchange fees for the credit cards, which can be related to fraud rates, can be monthly updated to reflect the current interchange fees imposed on the credit card.

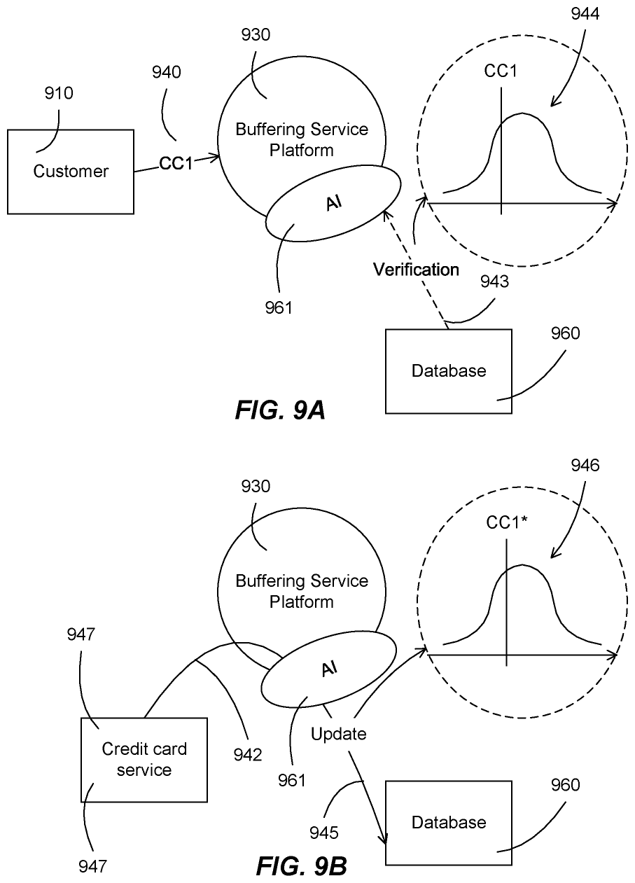

FIGS. 9A-9B illustrate schematics of processing a payment from a customer according to some embodiments. In FIG. 9A, a buffering service platform 930 can be configured to receive a payment 940, such as a credit card payment, from customer 910. The platform can process the credit payment, using a database 960, e.g., using data from the database to verify 943 the authentication of the credit purchase, such as to the identity of the customer, the credit limit imposed by the credit card issuer, or the interchange fee imposed by the credit card. In some embodiments, the platform 930 can have an AI module 961, which can be equipped with AI or machine learning, to assist in the analysis of the credit purchase.

As an example, a credit profile or pattern 944 of the credit payment of the customer can be shown, with the data CC1 showing the specific credit characteristic of the customer, such as the interchange fee for the credit card used by the customer.

In FIG. 9B, the platform 930 can receive 942 data from credit agencies 947, such as from a credit report agency, from data in the public domain, or from a banking institution, for information regarding the customers, such as credit history and other personal information. The data can be directly stored in the database 960, or can be processed by the AI module 961, such as for pattern analysis, before storing or updating 945 the raw data and the processed data in the database 960. The processed data can speed up the credit authentication process, e.g., allowing the customer usage patterns to be determined before an analysis of a new credit payment.

The platform 930 can also receive 940 data from the customers 910, such as from customer profiles supplied by the customers, or from data inferred from the customer location (through IP address, for example) and from customer equipment (through the equipment ID of the customer computer or cell phone). The data can be directly stored in the database 960, or can be processed by the AI module 961 before being stored in the database 960.

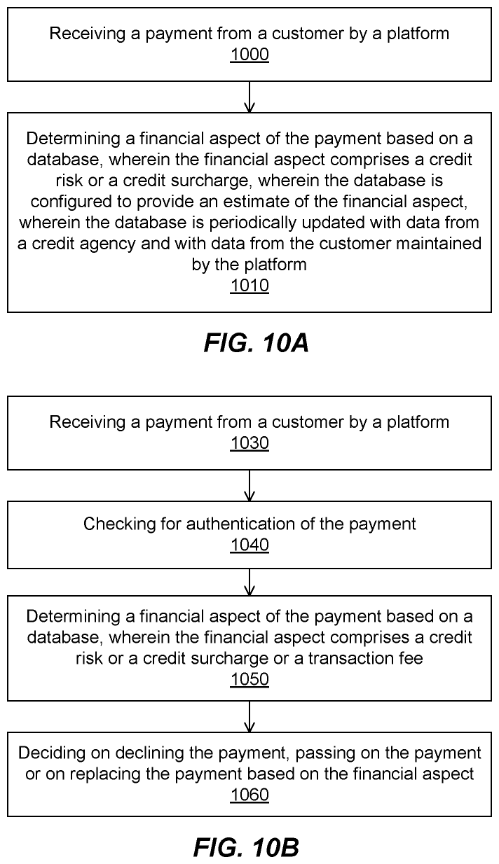

FIGS. 10A-10B illustrate flow charts for processing a payment from a customer according to some embodiments. In FIG. 10A, operation 1000 receives a payment from a customer by a platform. Operation 1010 determines a financial aspect of the payment based on a database. The financial aspect can include a credit risk or a credit surcharge. The database can be configured to provide an estimate of the financial aspect. The database can be periodically updated with data from a credit agency and with data from the customer maintained by the platform.

In FIG. 10B, operation 1030 receives a payment from a customer by a platform. Operation 1040 checks for authentication of the payment. Operation 1050 determines a financial aspect of the payment based on a database, with the financial aspect comprises a credit risk or a credit surcharge or an interchange fee. Operation 1060 decides on declining the payment, passing on the payment or on replacing the payment based on the financial aspect.

In some embodiments, the buffering service can send a payment to the supplier, after the buffering service receives a different payment from the customer. The buffering service can have an improved authentication process, such as based on an AI-processed database, and thus can significantly reduce the risk of fraudulent identity, e.g., accepting a stolen credit card. The risk reduction can be further transferred to the supplier, by the buffering accepting responsibility for the customer payment, e.g., the buffering service becomes the recipient of the customer payment, and not the supplier.

The buffering service then can send a different payment to the supplier, under the name of the customer and for a same amount. The payment from the buffering service to the supplier can be a credit card payment, such as a one-time-use credit card payment, since the same card is not likely to be used again. The one-time-use credit card can be a virtual card, in the sense that the one-time-use card can simply be a string of number, e.g., the number for the one-time-use credit card, and not a physical card. The one-time-use credit card is different from conventional virtual credit cards, since the conventional virtual credit cards are issued under the name of the owner of the actual or physical credit cards corresponding to the virtual credit cards.

In contrast, the present one-time-use credit cards are issued under the customer name, with the owner is actually the buffering service. Thus, the buffering service can have an agreement or a contract with a credit card issuing institution, such as with a bank, to supply the buffering service with multiple one-time-use credit cards having name and amount filled in by the buffering service.

In some embodiments, the one-time-use credit card can have as much similarity to the credit card used by the customer, for example, by having the same credit card association such as the same Visa or the same MasterCard, or by having the same last 4 digits of the credit card.

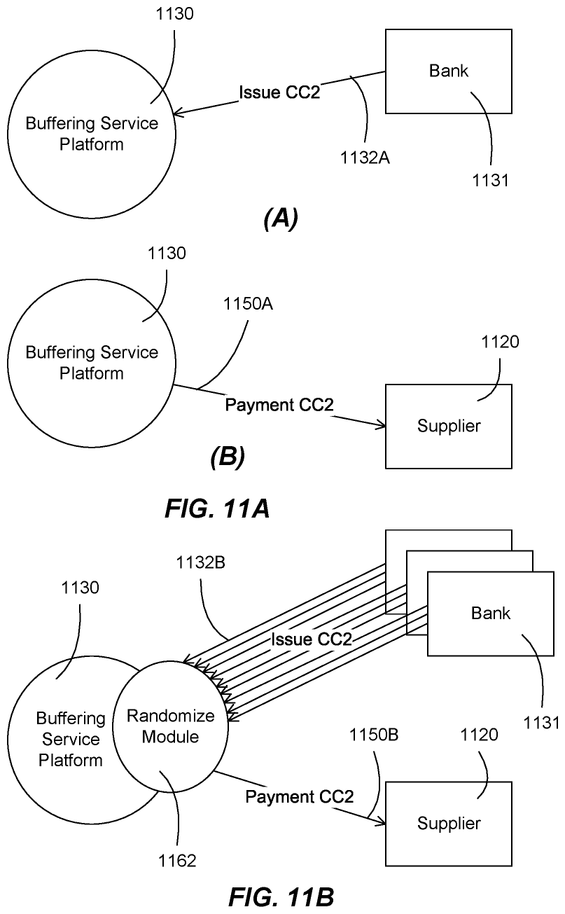

FIGS. 11A-11B illustrate schematics for processing a payment to a supplier according to some embodiments. FIGS. 11A(A) and 11A(B) show a process in which the buffering service sends a credit card payment to a supplier, after being issued the credit card by a credit card issuing institution, such as a bank.

In FIG. 11A(A), the buffering service platform 1130 can have an agreement with a bank 1131 that has the ability to issue credit cards. The agreement can provide that the bank will issue 1132A multiple one-time-use credit cards to the buffering service platform, with the card association (e.g., a Visa card, a MasterCard, etc.), the name on the card, and card amount to be supplied by the platform. The bank can issue a list of credit card numbers for the platform to choose. The card issuance can be based on a credit or a collateral of the platform. For example, the bank can agree to a daily or monthly credit limit based on the credit of the platform, e.g., after checking the credit worthiness of the platform.

In FIG. 11A(B), the buffering service platform 1130, after receiving a payment from a customer to pay for a product or service offered by a supplier 1120, can send 1150A a credit card payment to the supplier. The credit card can be a one-time-used credit card, with the name on the card being the name of the customer, and the amount on the card being the amount of the customer payment.

In some embodiments, the buffering service platform can have a randomizing module configured to select a credit card number among the credit card number supplied by a bank. Alternatively, the buffering service platform can have agreements with multiple banks, with each bank supplying a number of credit card numbers. The randomizing module can be configured to select a credit card number in a random fashion among the available credit card numbers.

The randomization can serve to avoid certain automatic fraud detection in some credit card processing services, which can automatically flag the payment as fraud when observing a repetition, multiple credit cards having a same characteristic in a short time period.

In FIG. 11B, the buffering service platform 1130 can have agreements with one or more credit card issuing banks 1131, which can issue 1132B multiple one-time-use credit cards to the buffering service platform, with the card association (e.g., a Visa card, a MasterCard, etc.), the name on the card, and card amount to be supplied by the platform.

The buffering service platform 1130, after receiving a payment from a customer to pay for a product or service offered by a supplier 1120, can use a randomizing module 1162 to randomly select a credit card among the available credit cards issued by the banks 1131. The platform then can send 1150B a payment to the supplier, using the randomly selected credit card number.

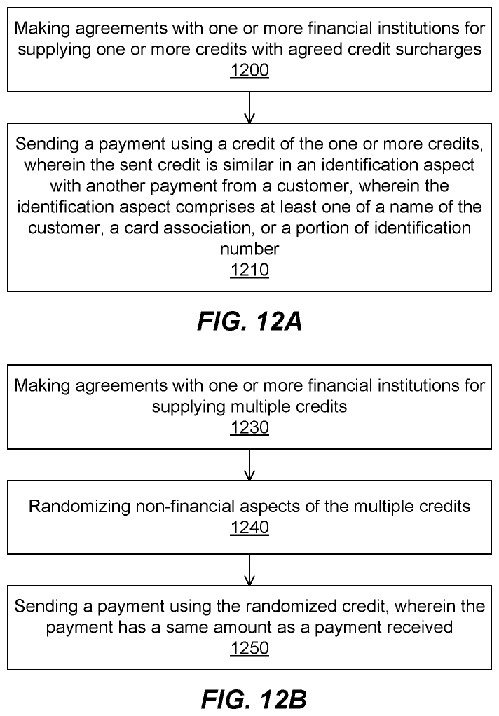

FIGS. 12A-12B illustrate flow charts for processing a payment to a supplier according to some embodiments. In FIG. 12A, operation 1200 makes agreements with one or more financial institutions for supplying one or more credit cards with agreed credit interchange fees. Operation 1210 sends a payment using a credit card of the one or more credit cards, with the sent credit card being similar in an identification aspect with another payment from a customer, and with the identification aspect including at least one of a name of the customer, a card association, or a portion of identification number.

In FIG. 12B, operation 1230 makes agreements with one or more financial institutions for supplying multiple credit cards. Operation 1240 randomizes aspects of the multiple credit cards to select a credit card. Operation 1250 sends a payment using the randomized credit card, with the payment having a same amount as a payment received, and a same name as a customer name.

In some embodiments, the payment to the supplier can be through a credit card or a debit card. The credit or debit card can be supplied by the platform, or can be provided by the supplier.

Since the payment from the buffering service is secured, the buffering service can guarantee the payment, for example, through a secured credit card, a preload debit card, or other forms of secure payments.

In some embodiments, the payment by the buffering service platform to the supplier can be a regular credit card payment, a secured credit card payment, a balance credit card payment, or a preload debit card payment. In a regular credit card payment, the supplier can get payment from credit card issued bank transferred to its bank.

In a secured credit card payment, the secured credit card is pre-loaded with cash, e.g., the secured credit card is based on cash collateral and not based on credit. Thus, the secured credit card is secured with the platform depositing money in the issuing bank. The secured credit card is different from a regular credit card is that in the regular credit card, the credit card issuing bank issues the credit card to the platform based on the credit worthiness of the platform.

In a balance credit card payment, the platform can transfer payment as balance to a credit card, with the credit card number supplied by the platform or by the supplier. For the credit card supplied by the platform, the platform can send to the supplier a preload balance credit card, e.g., a physically credit card or a virtual credit card (e.g., a credit card number), with the credit card having a balance amount equal to the amount of the payment.

For the credit card number supplied by the supplier, the supplier can provide the platform with a credit card number that can accept balance transfer. The platform then can send a payment, which can appear as a balance amount on the supplier supplied credit card. The supplier than can use the credit card for other payments, with the spending money subtracted from the balance of the credit card.

This mode of payment requires that the credit card provided by the platform or by the supplier accepts money transferred to the credit card in the form of a balance, e.g., the amount of money that the supplier overpaid the credit card. This mode of payment can be useful for some suppliers do not have regular access to bank, such as a foreign supplier, or for suppliers who prefer to carry money on a credit card.

In a preload debit card payment, the platform can transfer payment as preloaded money to a debit card, with the debit card number supplied by the platform or by the supplier. For the debit card supplied by the platform, the platform can send to the supplier a preload debit card, e.g., a physically debit card or a virtual debit card (e.g., a debit card number), with the debit card preloaded with the amount of the payment. For the debit card supplied by the supplier, the supplier can provide the platform with a debit card number. The platform then can load the received debit card with a payment, which can appear as a preloaded amount on the supplier supplied debit card.

After obtaining the preload debit card, which is either supplied by the platform or by the supplier, the supplier than can use the debit card for other payments, with the spending money subtracted from the balance of the preloaded debit card. This mode of payment can be useful for some suppliers do not have regular access to bank, such as a foreign supplier, or for suppliers who prefer to carry money on a debit card.

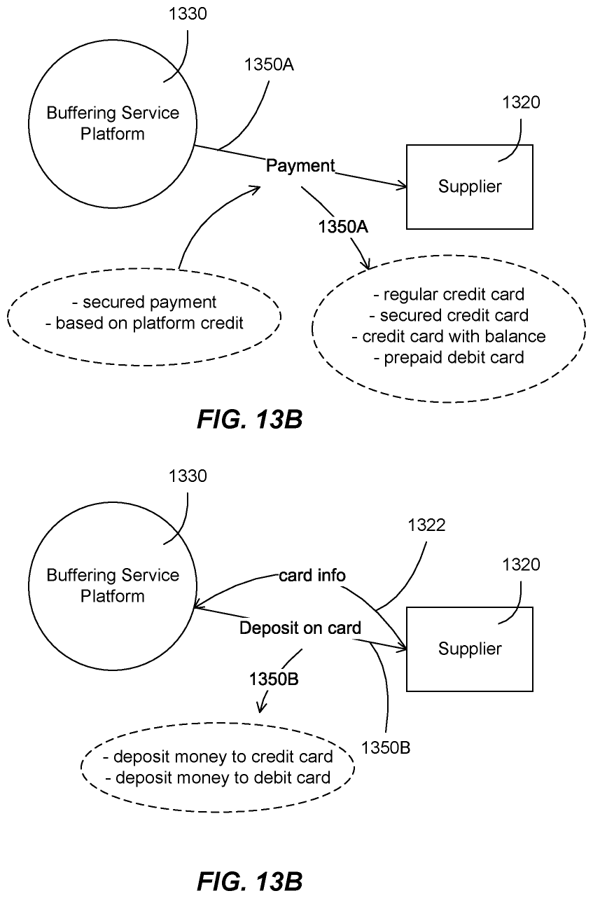

FIGS. 13A-13B illustrate schematics for payment configurations to a supplier according to some embodiments. In FIG. 13A, a buffering service platform 1330 can send 1350A a payment to a supplier 1320. The payment can be a secure payment, e.g., backed by the platform credit. The payment can be a regular credit card, e.g., the platform sending the supplier with a credit card number with an agreement to pay the customer amount from the credit card number. The payment can be a secured credit card, e.g., the platform sending the supplier with a credit card number with the credit card secured by cash instead of credit. The payment can be a balance credit card such as a credit card having a balance on the credit card, e.g., the platform sending the supplier with a credit card number with the credit card having a balance amount equal to the payment amount sent by the customer. The payment can be a preload debit card, e.g., the platform sending the supplier with a debit card number with the debit card being preloaded with an amount equal to the payment amount sent by the customer.

In FIG. 13B, the buffering service platform 1330 can receive 1322 information for a credit or debit card from the supplier 1320. The platform 1330 can send 1350B a payment to the supplier 1320, using the information supplied by the supplier. The payment can be a credit card with a balance, e.g., the platform putting money into the supplier provided credit card number in the form of a balance amount to the credit card, with the balance amount equal to the payment amount sent by the customer; or a preload debit card, e.g., the platform putting money into the supplier provided credit card number in the form of a preloaded amount to the debit card, with the preloaded amount equal to the payment amount sent by the customer.

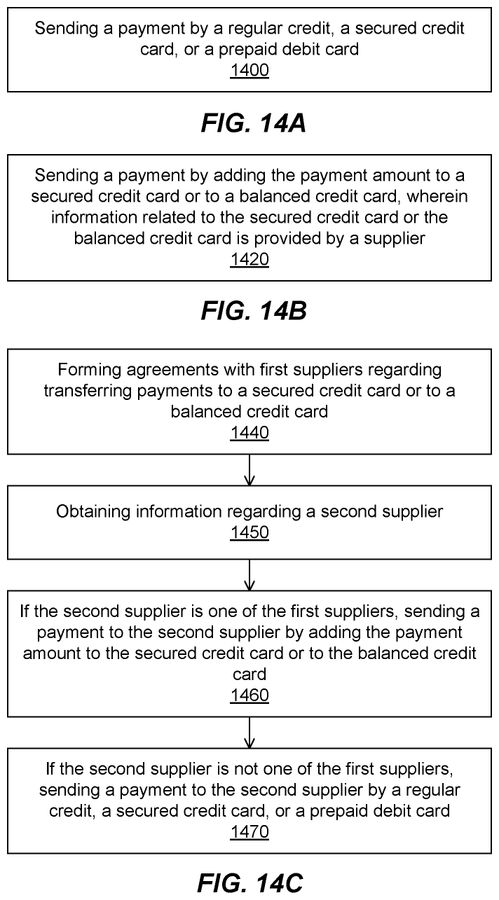

FIGS. 14A-14C illustrate flow charts for payment configurations to a supplier according to some embodiments. In FIG. 14A, operation 1400 sends a payment by a regular credit, a secured credit card, or a prepaid debit card.

In FIG. 14B, operation 1420 sends a payment by adding the payment amount to a secured credit card or to a balanced credit card, with information related to the secured credit card or the balanced credit card provided by a supplier.

In FIG. 14C, operation 1440 forms agreements with first suppliers regarding transferring payments to a secured credit card or to a balanced credit card. Operation 1450 obtains information regarding a second supplier. Operation 1460 sends a payment to the second supplier by adding the payment amount to the secured credit card or to the balanced credit card, if the second supplier is one of the first suppliers. Operation 1470 sends a payment to the second supplier by a regular credit, a secured credit card, or a prepaid debit card, if the second supplier is not one of the first suppliers.

In some embodiments, the buffering service platform can function as a one stop shop for the customers. The buffering service can be disposed between the suppliers and the customers, thus can function as a one-stop shop for the customers, e.g., instead of having multiple contacts, with each contact representing a supplier, the customers have a single contact of the buffering service. Every presale, sale, and post sale transaction can go to the buffering service.

For example, a customer can contact the buffering service to search for products and services offered by multiple suppliers. The buffering service is also configured to handle customer problems, e.g., the buffering service can represent the suppliers to discuss with the customers regarding issues such as payment, product, or service disputes

In some embodiments, the buffering service can be configured to isolate or shielding the suppliers from the customer disputes or financial actions, such as in events like complaints or chargebacks. For example, if a customer paid for an item but not received it, or received it damaged, the customer can dispute the charge with the buffering service to get the money back, instead of disputing with the supplier.

Chargebacks and refunds all allow the customers to get their money back for fraudulent charges or purchases that don't meet common standards. However, chargebacks are different from refunds, in which a refund comes directly from a supplier, while a chargeback comes from the card issuer.

A first step is to go to the supplier to ask for a refund. If the supplier refuses to credit the purchase, a chargeback can be requested from the card issuer. Situations that qualify for requesting a chargeback include fraud or unauthorized charges, products or services that not delivered, damaged or defective items, and incorrect charges.

In some embodiments, the buffering service can be configured to shift fraudulent risk such as refunds or chargebacks from the suppliers to the buffering service, for example, by accepting the payments from the customers. The fraudulent risk can be acceptable to the buffering service due to the improve fraud detection based on the AI processed database.

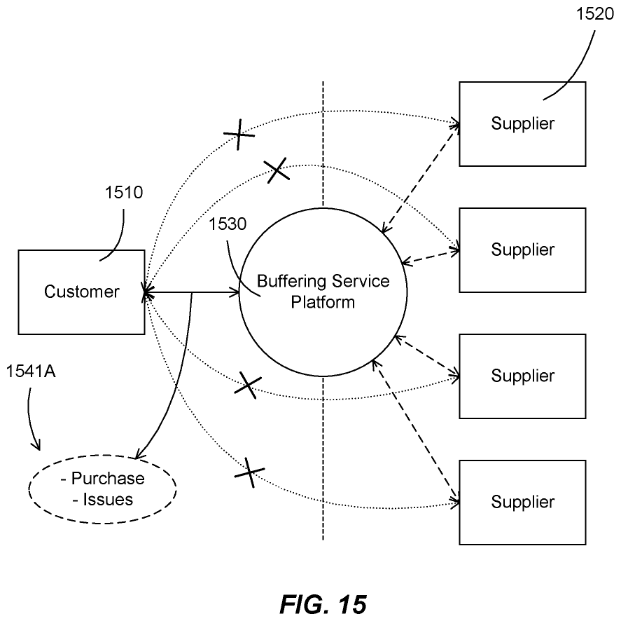

FIG. 15 illustrates a schematic for a buffering configuration according to some embodiments. A buffering service 1530 can serve as a platform between the customers 1510 and the suppliers 1520. The buffering service can function as a one-stop shop for the customers, e.g., the customers can discuss issues 1541A related to the purchases with the platform, instead of to multiple individual suppliers.

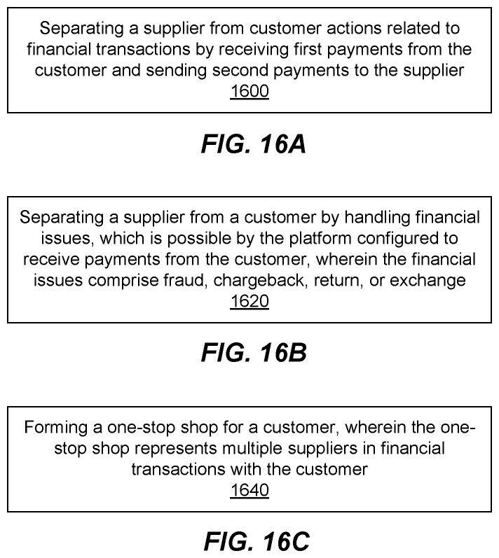

FIGS. 16A-16C illustrate flow charts for shielding configurations to a supplier according to some embodiments. In FIG. 16A, operation 1600 separates a supplier from customer actions related to financial transactions by receiving first payments from the customer and sending second payments to the supplier. In FIG. 16B, operation 1620 separates a supplier from a customer by handling financial issues, which is possible by the platform configured to receive payments from the customer, with the financial issues including fraud, chargeback, return, or exchange. In FIG. 16C, operation 1640 forms a one-stop shop for a customer, wherein the one-stop shop represents multiple suppliers in financial transactions with the customer.

In some embodiments, the present invention discloses a buffering service platform functioning as a one-stop-shop for customers in dealing with multiple suppliers. The platform can also assist the suppliers in taking the risk of credit payments from the customers. The suppliers can receive payments from the platform, which is secured and can be guaranteed by the platform.

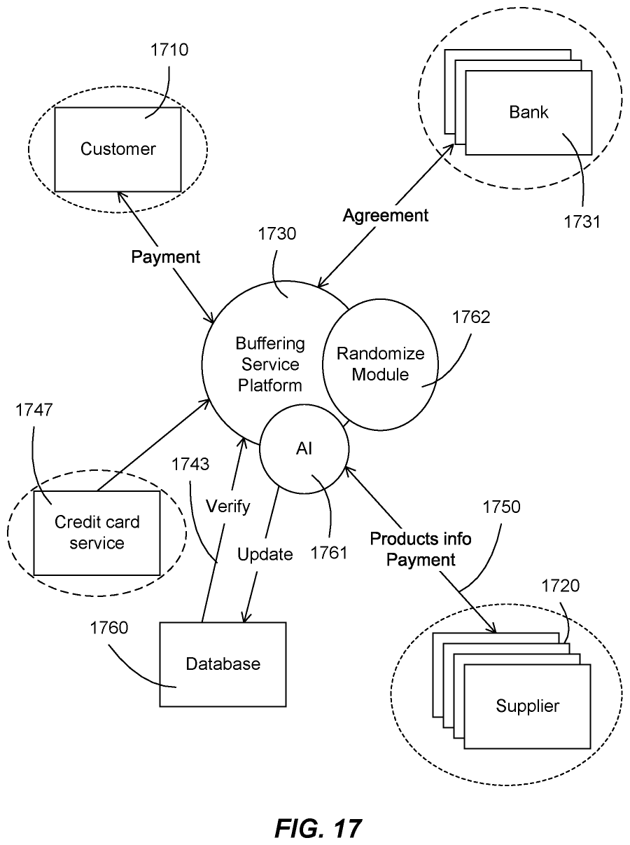

FIG. 17 illustrates a schematic of a buffering service platform according to some embodiments. The buffering service platform 1730 can be configured to receive payments from customers 1710, and then send another payment to suppliers 1720. The buffering service platform can include a constantly update database 1740 to know customer credit information, agreements with banks 1741 to generate credit or debit used for payment. The buffering service platform can include an AI module to process the data from the database to reduce the risk of fraudulent identities. The buffering service platform can include a randomizing module to randomly select a credit card, e.g., selecting one or more aspects of the credit cards issued by the banks as a result of the agreements. The buffering service platform can function as a one stop shop for customer in dealing with multiple suppliers, and can handle all post sale transactions for the suppliers. The buffering service platform can also function as a buffer for the suppliers, for example, to shield the suppliers from fraudulent transactions.

For example, a buffering service platform 1730 can be configured to provide products and services from one or more suppliers 1720 to customers 1710. In operation, upon receiving an inquiry from a customer, the platform can search inventories of the suppliers and then display the search results for the customer. The customer can select one or more products or services, and can proceed for payment, such as by a credit card. The platform can process the credit payment, using a database 1760, e.g., using data from the database to verify 1743 the authentication of the credit purchase, such as to the identity of the customer. In some embodiments, the platform 1730 can have an AI module 1761, which can be equipped with AI or machine learning, to assist in the analysis of the credit purchase.

The database 1740 can be updated with data from credit card services 1757, together with public and private data from social media or from banking institutions. The database can also be updated with data from the customers, e.g., by customer supplying information in a questionnaire or in agreement to have data stored in the database.

The platform can have agreements with one or more banks 1731 to issue credit cards, such as one-time-use credit cards. The platform can be configured to send 1750 another different payment to the supplier. The payment from the platform can be more secured than the payment from the customer, since the platform is known to the supplier, for example, through an agreement to display products or services on the platform. The payment can be a credit card payment, with the credit card selected among the credit cards issued by the banks 1731.

The platform can include a randomizing module 1762, which can be configured to randomly selecting a credit card among the available credit cards. For example, the random selection can be among the bin number of the credit card number, or can be among the credit number. The credit card can have the same card association and the card holder name as those of the customer.

The platform can be configured to handle all post sale transactions from the customer. The customer can communicate with the platform regarding issues related to the payment from the customer, such as a fraudulent transaction from a stolen credit card. The platform can settle the fraud charges with the customer, without involving the supplier. For issues related to the products or services obtained by the customer, such as a broken product or a poor-performance service, the platform can function as an intermediate or an arbiter between the customer and the supplier. For example, the platform can discuss the issues with the customer, and also discuss the issues with the supplier using the argument with the customer. Thus, the customer and the supplier can be seen as dealing only with the platform.

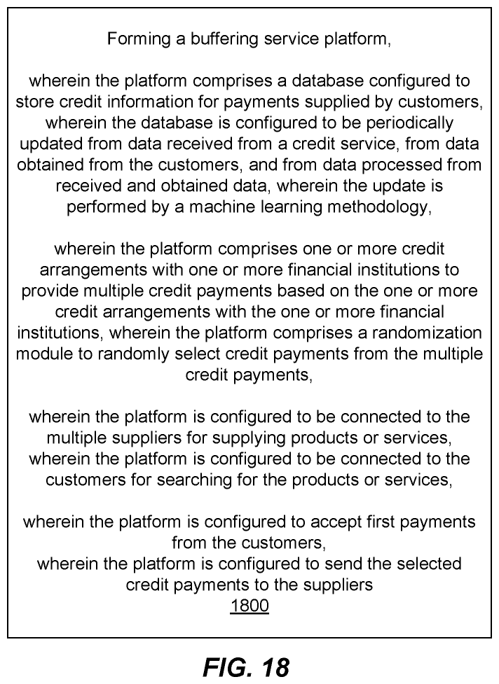

FIG. 18 illustrates a flow chart for forming a buffering service platform according to some embodiments. Operation 1800 forms a buffering service platform. The platform can include a database configured to store credit information for payments supplied by customers. The database can be configured to be periodically updated from data received from a credit service, from data obtained from the customers, and from data processed from received and obtained data. The update can be performed by a machine learning methodology. The platform can include one or more credit arrangements with one or more financial institutions to provide multiple credit payments based on the one or more credit arrangements with the one or more financial institutions. The platform can include a randomization module to randomly select credit payments from the multiple credit payments. The platform can be configured to be connected to the multiple suppliers for supplying products or services. The platform can be configured to be connected to the customers for searching for the products or services. The platform can be configured to accept first payments from the customers. The platform can be configured to send the selected credit payments to the suppliers.

In some embodiments, the buffering service platform can be used as a travel reservation platform in which the customers are configured to make travel reservations from travel suppliers such as airlines, car rental companies or hotel managements.

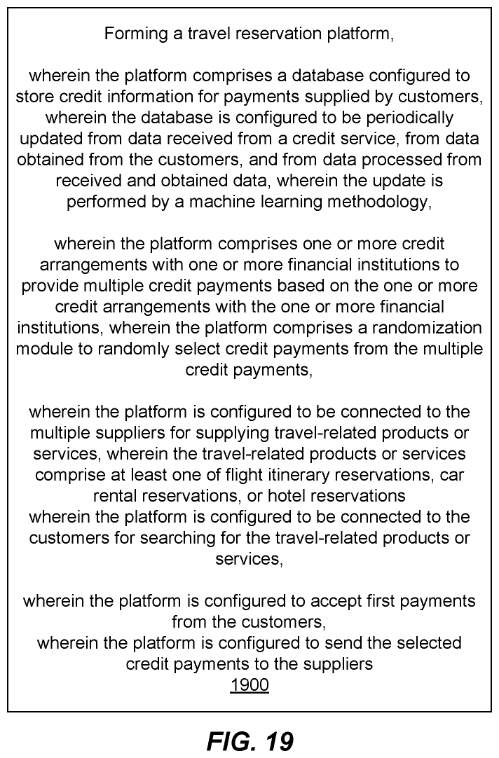

FIG. 19 illustrates a flow chart for forming a travel reservation platform according to some embodiments. Operation 1900 forms a travel reservation platform. The platform comprises a database configured to store credit information for payments supplied by customers. The database is configured to be periodically updated from data received fro m a credit service, from data obtained from the customers, and from data processed from received and obtained data. The update is performed by a machine learning methodology. The platform comprises one or more credit arrangements with one or more financial institutions to provide multiple credit payments based on the one or more credit arrangements with the one or more financial institutions. The platform comprises a randomization module to randomly select credit payments from the multiple credit payments. The platform is configured to be connected to the multiple suppliers for supplying travel-related products or services. The travel-related products or services comprise at least one of flight itinerary reservations, car rental reservations, or hotel reservations. The platform is configured to be connected to the customers for searching for the travel-related products or services. The platform is configured to accept first payments from the customers. The platform is configured to send the selected credit payments to the suppliers.

In some embodiments, the buffering service platform in general, or a travel reservation platform in particular, can be configured to function as a buffering service between customers and suppliers. From a financial point of view, the payment process from the customers to the suppliers can be divided into two distinct and separate payment processes. A first payment process is from the customers to the platform, in which the platform can perform credit verification, receive the payment, and handle post-sale transactions or disputes. A second payment process is from the platform to the suppliers, in which the platform can issue credit payments to the suppliers. The credit payments from the platform can come from prior credit agreements that the platform has with multiple financial institutions.

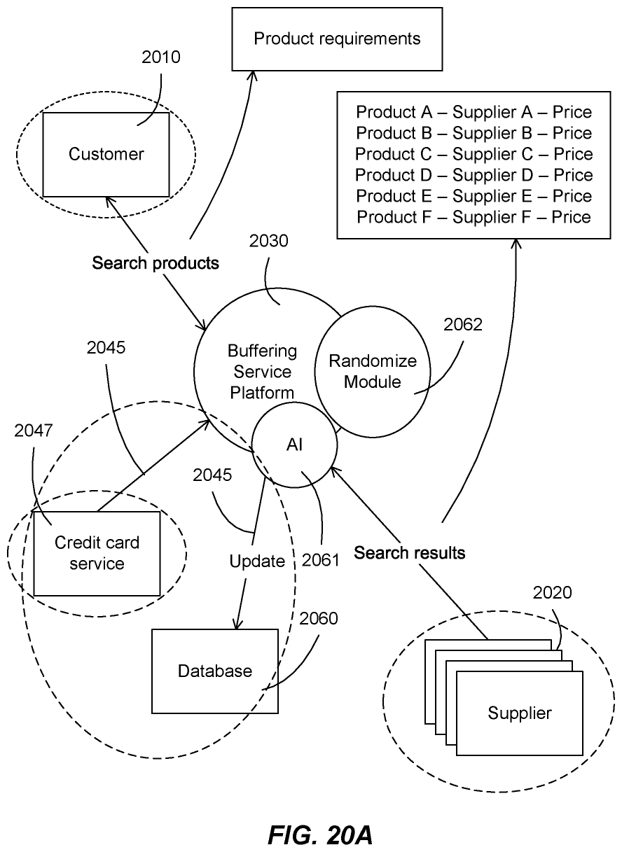

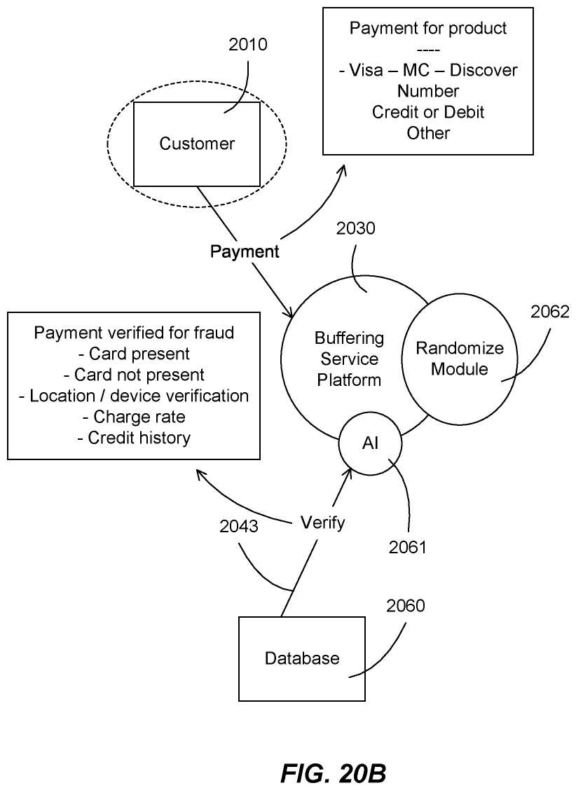

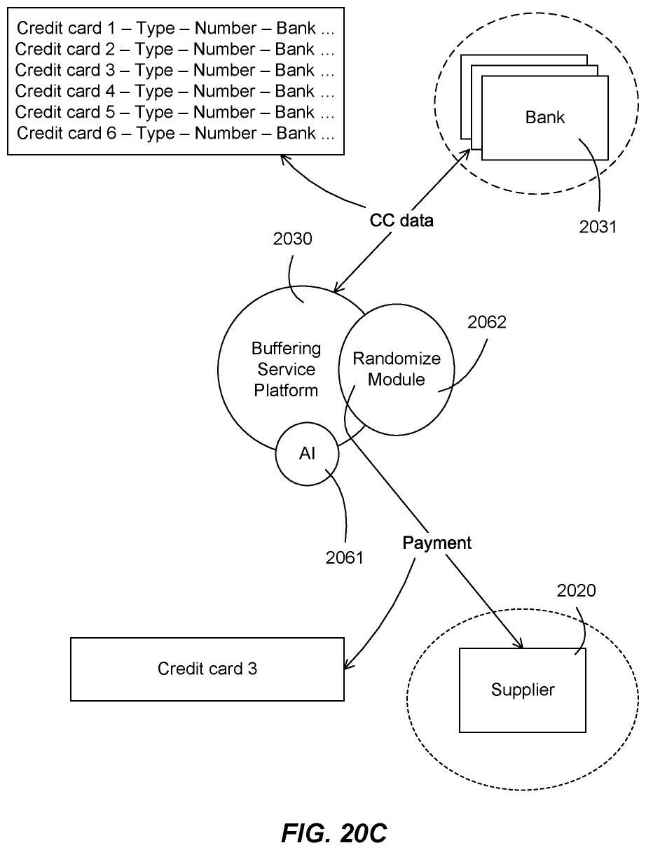

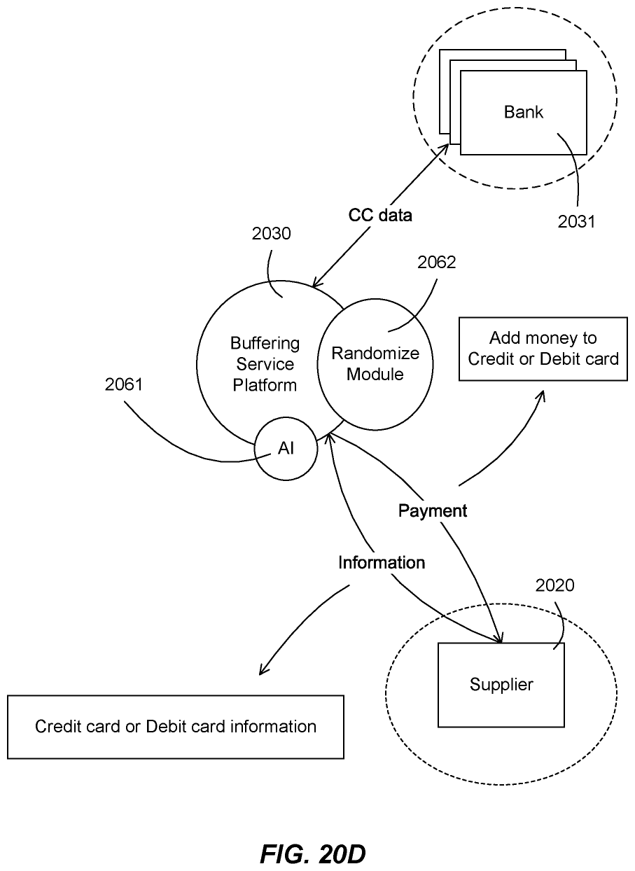

FIGS. 20A-20D illustrate operation schematics for a buffering service platform according to some embodiments. In FIG. 20A, a buffering service platform 2030 can be configured to provide products and services from one or more suppliers 2020 to customers 2010. In operation, a customer 2010 can send a search request for a product to the platform 2030. In some embodiments, the buffering service platform can be a platform configured to sell products or services on-line or through a network such as the Internet. For example, the platform can be a travel reservation platform, with the suppliers being the individual airlines or airline networks such as GDS, or bus or train services, or car rental companies, or lodging accommodation such as hotel companies or airbnb. The travel reservation platform can be linked to customers looking to make travel reservations, such as looking to book an air flight, reserving a car rental, and a hotel for the duration of the travel.

The search request can include requirements for the product, such as the name or description of the product to be searched. For example, in the case of the travel reservation platform, the search request can be an air flight search, and can include the departure and arrival locations, together with the date of travel.

The platform, linked to inventories of the suppliers 2020, can then perform a search on the inventories and then returns the search results to be displayed on the customer system. For example, the search results can include a list of products matching the requirements of the search request, together with the name of the supplier, the price of the products, and other information such as descriptions and reviews for the products. In the case of the travel reservation platform, the search results can include a list of flight itineraries having the departure and arrival locations and the date of travel matching the requirements of the flight search request. The list of flight itineraries can include the airline operating the air flight, and the price of the air flight, together with other information such as no stop, one stop, and layover time.

In FIG. 20B, the customer can select one or more products or services, and can proceed for payment, such as by a credit card. For example, in the case of the travel reservation platform, the customer can select a flight itinerary, and then perform a check out to open a payment screen. The customer then can select a payment method, such as paying by a credit card or by a debit card. The customer then can enter the required information, such as the name on the card, the card number, the expiration date, and optionally the CVC code.

The platform can process the credit payment, using a database 2060, e.g., using data from the database to verify 2043 the authentication of the credit purchase, such as to the identity of the customer. The platform can use additional authentication security steps, such as obtaining location and machine identification of the customer during the payment transaction. The platform can use an AI module 2061, which can be equipped with AI or machine learning, to assist in the analysis of the authentication process, such as to match the additional authentication security steps, and to analyze the characteristics of the credit card purchase against the spending behavior or patterns derived from the historical data of the customer stored in the database.

The database 2040 can be updated with data from credit card services 2057, together with public and private data from social media or from banking institutions. The database can also be updated with data from the customers, e.g., by customer supplying information in a questionnaire or in agreement to have data stored in the database. With the AI assisted authentication process using additional authentication security steps and the constantly updated database, the platform can be confident about the determined risk of fraudulent identity, such as in the case of stolen credit cards.

In some embodiments, the platform is confident enough about its ability to detect fraudulent identity to assume the financial risk of accepting the credit payment from the customer. To assume the financial risk, the platform can receive the customer payment, and then using the platform credit to send a different payment to the supplier.

In some embodiments, the present invention discloses a two step payment process, which can include a first payment from the customer to the platform, and a second payment from the platform to the supplier, to replace the one step payment process of the customer sending payment to the supplier through the platform.

In FIG. 20C, the platform can have agreements with one or more banks 2031 to issue credit or debit cards, such as one-time-use credit cards. For example, the banks can issue the platform with a list of credit or debit cards, including the credit or debit card number (card association number, bin number, account number, and check sum number). The list of credit or debit cards can include the card association and the issuing bank. The credit or debit cards can include regular credit cards, secured credit cards, credit cards with allowable balance (e.g., balance credit cards), or preload debit cards.

The platform can be configured to send 2050 a payment to the supplier. The payment from the platform to the supplier is different from the payment from the customer to the platform. For example, the payment from the platform can be more secured than the payment from the customer, since the platform is known to the supplier, for example, through an agreement to display products or services on the platform. The payment can be a credit or debit card payment, with the credit or debit card selected among the credit or debit cards issued by the banks 2031.

The platform can include a randomizing module 2062, which can be configured to randomly selecting a credit or debit card among the available credit or debit cards. For example, the random selection can be among the bin number of the credit card number, or can be among other numbers of the credit number. The credit card can have the same card association and the card holder name as those of the customer.

In some embodiments, the randomization can be configured to avoid automatic fraud detection in some credit card processing services, which can automatically flag the payment as fraud when observing a repetition, such as detecting multiple credit cards having a same characteristic in a short time period.

FIG. 20D shows an alternative payment process from the platform to the supplier. The platform can have agreements with one or more banks 2031 to issue credit or debit cards, such as one-time-use credit cards, including transferring funds into the security of a secured credit card, transferring funds as a balance into a balance credit card, or transferring funs into a preload debit card.

The platform can be configured to send a payment to the supplier using information supplied by the supplier. For example, the supplier can provide the platform with information regarding a credit card or a debit card that the supplier wants the platform to use. The platform then can send payment, in the form of a balance if the supplier provides a balance credit card, in the form of a preload debit card if the supplier provides a debit card.

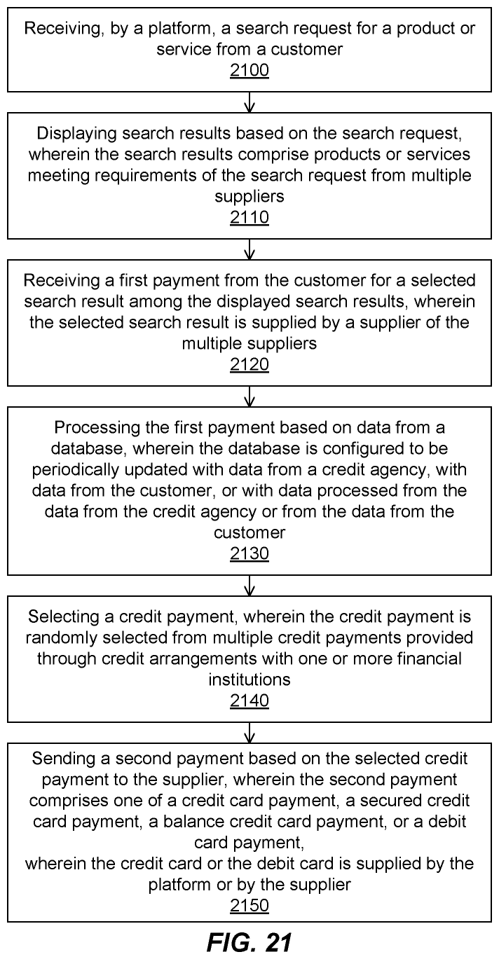

FIG. 21 illustrates a flow chart for operating a buffering service platform according to some embodiments. Operation 2100 receives, by a platform, a search request for a product or service from a customer. Operation 2110 displays search results based on the search request, with the search results showing products or services meeting requirements of the search request from multiple suppliers. Operation 2120 receives a first payment from the customer for a selected search result among the displayed search results, with the selected search result supplied by a supplier of the multiple suppliers. Operation 2130 processes the first payment based on data from a database. The database is configured to be periodically updated with data from a credit agency, with data from the customer, or with data processed from the data from the credit agency or from the data from the customer. Operation 2140 selects a credit payment, wherein the credit payment is randomly selected from multiple credit payments provided through credit arrangements with one or more financial institutions. Operation 2150 sends a second payment based on the selected credit payment to the supplier, wherein the second payment comprises one of a credit card payment, a secured credit card payment, a balance credit card payment, or a debit card payment, with the credit card or the debit card supplied by the platform or by the supplier.

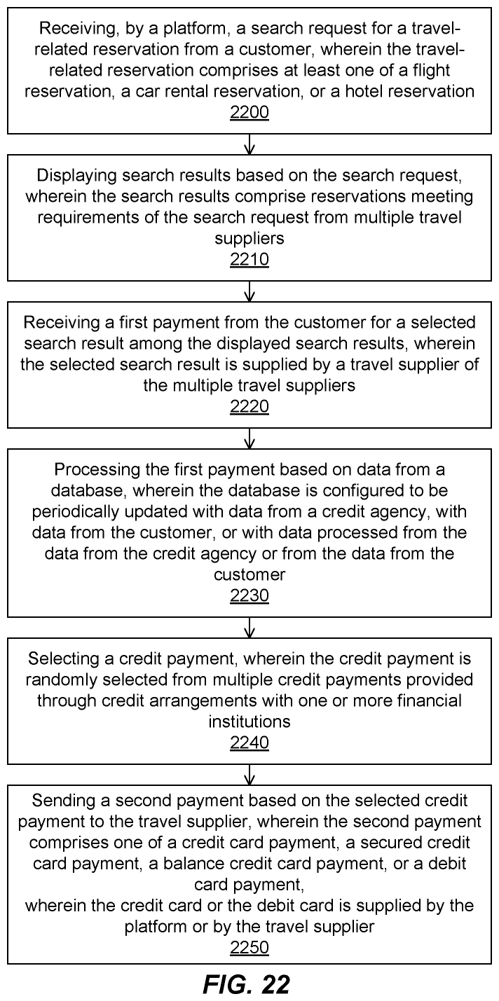

FIG. 22 illustrates a flow chart for operating a travel reservation platform according to some embodiments. Operation 2200 receives, by a platform, a search request for a travel-related reservation from a customer, with the travel-related reservation including at least one of a flight reservation, a car rental reservation, or a hotel reservation. Operation 2210 displays search results based on the search request, with the search results showing reservations meeting requirements of the search request from multiple travel suppliers. Operation 2220 receives a first payment from the customer for a selected search result among the displayed search results, with the selected search result supplied by a travel supplier of the multiple travel suppliers. Operation 2230 processes the first payment based on data from a database, with the database configured to be periodically updated with data from a credit agency, with data from the customer, or with data processed from the data from the credit agency or from the data from the customer. Operation 2240 selects a credit payment, with the credit payment optionally randomly selected from multiple credit payments provided through credit arrangements with one or more financial institutions. Operation 2250 sends a second payment based on the selected credit payment to the travel supplier. The second payment can include one of a credit card payment, a secured credit card payment, a balance credit card payment, or a debit card payment, with the credit card or the debit card supplied by the platform or by the travel supplier.

In some embodiments, the present invention discloses a computer program having machine-readable instructions to cause a processing device to implement any one of the methods described above. The present invention also discloses a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, or a nonvolatile electronic memory. The software program may be run on a variety of devices, including a processor or a processing device to perform any one of the methods described above.

In some embodiments, the methods can be realized in hardware, software, or a combination of hardware and software. The methods can include computer-implemented methods, using a computer or a data processing system to execute the methods, including executing operations by a hardware processor. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

In some embodiments, the present invention discloses a system having a non-transitory memory and one or more hardware processors coupled to the non-transitory memory and configured to read instructions from the non-transitory memory to cause the system to perform operations necessary to perform the methods described above.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

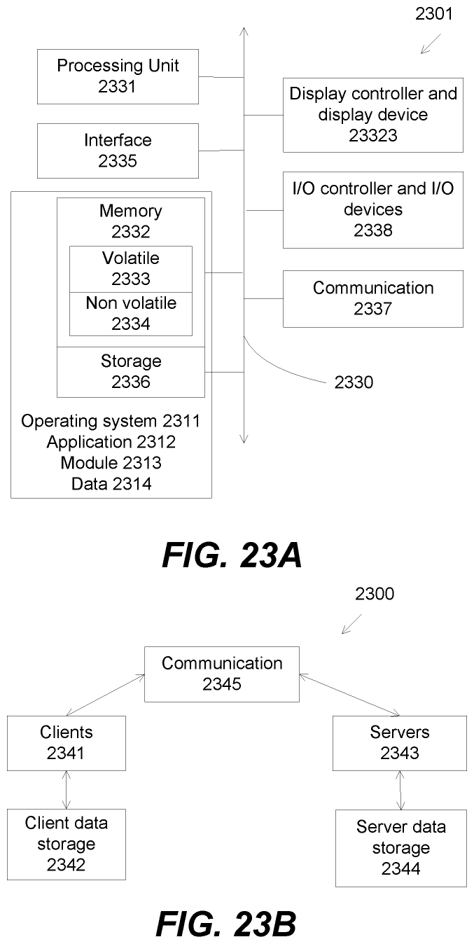

FIGS. 23A-23B illustrate computing environments according to some embodiments. FIG. 23A shows a computing environment. An exemplary environment for implementing various aspects of the invention includes a computer 2301, comprising a processing unit 2331, a system memory 2332, and a system bus 2330. The processing unit 2331 can be any of various available processors, such as single microprocessor, dual microprocessors or other multiprocessor architectures. The system bus 2330 can be any type of bus structures or architectures. The system memory 2332 can include volatile memory 2333 and nonvolatile memory 2334.

Computer 2301 also includes storage media 2336, including removable storage media or nonremovable storage media, and volatile or nonvolatile disk storage. A removable or non-removable interface 2335 can be used to facilitate connection. These storage devices can be considered as part of the I/O device 2338 or at least they can be connected via the bus 2330. Storage devices that are “on board” generally include EEPROM used to store the BIOS.

The computer system 2301 further can include software to operate in the environment, such as an operating system 2311, system applications 2312, program modules 2313 and program data 2314, which are stored either in system memory 2332 or on disk storage 2336. Various operating systems or combinations of operating systems can be used.

Input devices can be used to enter commands or data, and can include a pointing device such as a mouse, stylus, touch pad, and other devices such as keyboard, microphone, connected through interface ports 2338. Interface ports 2338 can include connection ports, such as serial ports, parallel ports, or universal serial buses (USB). The interface ports 2338 can also accommodate output devices. For example, a USB port may be used to provide input to computer 2301 and to output information from computer 2301 to an output device. Output adapter 2339, such as video or sound cards, is provided to connect to some output devices such as monitors, speakers, and printers.

Computer 2301 can operate in a networked environment with remote computers. The remote computers, including a memory storage device, can be a data processing system, such as a personal computer, or a workstation, and typically includes many or all of the elements described relative to computer 2301. Remote computers can be connected to computer 2301 through a network interface 2335 and communication connection 2337, with wire or wireless connections. Network interface 2335 can be communication networks such as local-area networks (LAN), wide area networks (WAN) or wireless connection networks.

FIG. 23B shows a schematic block diagram of a sample computing environment with which the present invention can interact. The system 2300 includes a plurality of client systems 2341. The system 2300 also includes a plurality of servers 2343. The servers 2343 can be used to employ the present invention. The system 2300 includes a communication network 2345 to facilitate communications between the clients 2341 and the servers 2343. Client data storage 2342, connected to client system 2341, can store information locally. Similarly, the server 2343 can include server data storages 2344.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
forming a database comprising information of multiple persons for assessing estimates of risks of fraudulent payments,
wherein the information is related to habit in purchasing of the multiple persons,
wherein the information comprises at least one of individual knowledge comprising at least one of a password, a PIN number, secret questions, or a numerical sequence, individual possession comprising at least one of a mobile phone, wearable devices, a token, or a smartcard, individual inherent feature comprising at least one of fingerprint, voice recognition, iris recognition, or facial features, and
wherein the information is collected and processed to enter the database;
receiving, by a platform, a first payment using a first credit or debit card from a customer,
wherein the first payment comprises an amount of fund to pay for a service or product provided by a supplier;
assessing, by the platform, a risk of the first payment being a fraudulent payment using at least the database to provide an estimate of the fraudulent risk;
accepting, by the platform, the first payment comprising the amount of fund;
periodically updating, by the platform, the database to provide a better estimate of the fraudulent risk;
randomizing, by the platform, one or more processing characteristics of a second credit or debit card,
wherein the second credit or debit card is owned by the platform and issued by a financial institution having an agreement with the platform;
obtaining, by the platform, multiple credit or debit cards issued to the platform based on one or more agreements of the platform with one or more financial institutions based on a credit or a collateral of the platform;
selecting the second credit or debit card from the multiple credit or debit cards; and
issuing, by the platform, a second payment using the second credit or debit card,
wherein the second payment is issued to the supplier for the service or product,
wherein the second payment is different from the first payment in terms of ownership, and
wherein the second payment is issued under a name of the customer.

2. The method of claim 1, further comprising:
displaying search results to the customer based on a search request from the customer, wherein the first payment is received based on the customer selecting the product or service provided by the supplier.

3. The method of claim 1, wherein assessing the risk of a fraudulent payment comprises authenticating an identity of the customer.

4. The method of claim 1, further comprising:
checking for an interchange fee associated with the first payment.

5. The method of claim 1, wherein updating the database further comprises updating the database with data from credit agencies, with data from financial institutions, and with data from the customer including data supplied to the platform by the customer or data inferred from communication between the customer and the platform, the platform comprising at least one of location or communication equipment.

6. The method of claim 1, wherein the estimate of the fraudulent risk is performed by an artificial intelligent algorithm characterizing the first payment to be whether or not a deviation from spending patterns of the customer based on the purchasing habit of the customer, wherein a high risk level causes the artificial intelligent algorithm to perform additional authentication steps.

7. The method of claim 1, wherein the estimate of the fraudulent risk is performed by characterizing the first payment against spending patterns of the customer, with additional authentication steps used for a high risk level.

8. (canceled)

9. The method of claim 1, further comprising:
wherein randomizing the one or more processing characteristics of a second credit or debit card comprises randomly selecting aspects of the second credit or debit card from the multiple credit or debit cards.

10. The method of claim 1, wherein randomizing the one or more processing characteristics comprises randomly selecting at least one of an issuing bank, an account number for the second credit or debit card, a bin number of the second credit or debit card number, or an association of the second credit or debit card.

11. The method of claim 1, wherein randomizing the one or more processing characteristics comprises avoiding clustering the second payment with subsequent or previous payments to prevent a repetition comprising multiple credit cards having a same characteristic in a predetermined time period.

12. The method of claim 1, further comprising:
securing, by the platform, the second payment based on a credit or a collateral of the platform.

13. The method of claim 1, wherein the second payment comprises a one-time credit card payment for the amount of fund.

14. The method of claim 1,
wherein randomizing the one or more processing characteristics of a second credit or debit card comprises selecting the second credit or debit card with a same association as the first credit or debit card, or
wherein randomizing the one or more processing characteristics of a second credit or debit card comprises selecting the second credit or debit card with a portion of the second credit or debit card number similar to that of the first credit or debit card.

15. The method of claim 1, wherein issuing the second payment using the second credit or debit card comprises issuing a payment using a balance credit card or a preload debit card.

16. The method of claim 1, wherein issuing the second payment comprises:
receiving a credit card or a debit card number from the supplier, and
transferring the amount of fund to the credit card or a debit card number received from the supplier.

17.-20. (canceled)

21. A method comprising:
forming a database comprising information of multiple persons for assessing estimates of risks of fraudulent payments,
wherein the information is related to habit in purchasing of the multiple persons,
wherein the information comprises at least one of individual knowledge comprising at least one of a password, a PIN number, secret questions, or a numerical sequence, individual possession comprising at least one of a mobile phone, wearable devices, a token, or a smartcard, individual inherent feature comprising at least one of fingerprint, voice recognition, iris recognition, or facial features, and
wherein the information is collected and processed to enter the database;
receiving, by a platform, a first payment using a first credit or debit card from a customer, wherein the first payment comprises an amount of fund to pay for a service or product provided by a supplier;
assessing, by the platform, a risk of the first payment being a fraudulent payment using at least a database to provide an estimate of the fraudulent risk,
wherein the estimate of the fraudulent risk is performed by an artificial intelligent algorithm characterizing the first payment to be whether or not a deviation from spending patterns of the customer based on the purchasing habit of the customer, and
wherein a high risk level causes the artificial intelligent algorithm to perform additional authentication steps;
accepting, by the platform, the first payment comprising the amount of fund;
periodically updating, by the platform, the database to provide a better estimate of the fraudulent risk,
wherein updating the database further comprises updating the database with data from credit agencies, with data from financial institutions, and with data from the customer including data supplied to the platform by the customer or data inferred from communication between the customer and the platform comprising at least one of location or communication equipment;
randomizing, by the platform, one or more processing characteristics of a second credit or debit card, wherein the second credit or debit card is owned by the platform and issued by a financial institution having an agreement with the platform;
obtaining, by the platform, multiple credit or debit cards issued to the platform based on one or more agreements of the platform with one or more financial institutions based on a credit or a collateral of the platform, wherein randomizing the one or more processing characteristics of a second credit or debit card comprises randomly selecting aspects of the second credit or debit card from the multiple credit or debit cards; and
issuing, by the platform, a second payment using the second credit or debit card, wherein the second payment is issued to the supplier for the service or product, wherein the second payment is different from the first payment in term of ownership, and wherein the second payment is issued under a name of the customer.

22.-23. (canceled)

24. A method comprising:
forming a database comprising information of multiple persons for assessing estimates of risks of fraudulent payments,
wherein the information is related to habit in purchasing of the multiple persons,
wherein the information comprises at least one of individual knowledge comprising at least one of a password, a PIN number, secret questions, or a numerical sequence, individual possession comprising at least one of a mobile phone, wearable devices, a token, or a smartcard, individual inherent feature comprising at least one of fingerprint, voice recognition, iris recognition, or facial features, and
wherein the information is collected and processed to enter the database;
receiving, by a platform, a first payment using a first credit or debit card from a customer, wherein the first payment comprises an amount of fund to pay for a service or product provided by a supplier;
assessing, by the platform, a risk of the first payment being a fraudulent payment using at least a database to provide an estimate of the fraudulent risk;
accepting, by the platform, the first payment comprising the amount of fund;
periodically updating, by the platform, the database to provide a better estimate of the fraudulent risk,
wherein updating the database further comprises updating the database with data from credit agencies, with data from financial institutions, and with data from the customer including data supplied to the platform by the customer or data inferred from communication between the customer and the platform comprising at least one of location or communication equipment;
randomizing, by the platform, one or more processing characteristics of a second credit or debit card,
wherein the second credit or debit card is owned by the platform and issued by a financial institution having an agreement with the platform;
wherein randomizing the one or more processing characteristics of a second credit or debit card comprises selecting the second credit or debit card with a same association as the first credit or debit card, or
wherein randomizing the one or more processing characteristics of a second credit or debit card comprises selecting the second credit or debit card with a portion of the second credit or debit card number similar to that of the first credit or debit card; and
issuing, by the platform, a second payment using the second credit or debit card,
wherein the second payment is issued to the supplier for the service or product,
wherein the second payment is different from the first payment in term of ownership,
wherein the second payment is issued under a name of the customer.

25. The method of claim 24, wherein the estimate of the fraudulent risk is performed by characterizing the first payment against spending patterns of the customer, with additional authentication steps used for a high risk level.
